(19) United States
(12) Patent Application Publication
(10) Pub. No.: US 2005/0125527 A1
(43) Pub. Date: Jun. 9, 2005

(54) Method of identifying and managing an electronic device

(75) Inventors: Ming-Yih Lu, Taipei City (TW); Huang-Lung Tzeng, Taipei City (TW)

Correspondence Address: BACON & THOMAS, PLLC, 625 SLATERS LANE, FOURTH FLOOR, ALEXANDRIA, VA, 22314, US

(73) Assignee: Tatung Co., Ltd., Taipei City (TW)

(21) Appl. No.: 10/866,749

(22) Filed: Jun. 15, 2004

(30) Foreign Application Priority Data
Dec. 3, 2003 (TW) 092134087

(51) Int. Cl. G06F 15/173

(52) U.S. Cl. 709/223

(57) ABSTRACT

An electronic device has a user interface to control operations of at least one Ethernet network switch in a computer device to manage networking operations of the computer device. Connecting ports provided by the Ethernet network switch are divided into one or more types; ID codes are set to correspond to the types; sequentially different ID codes are assigned to the corresponding types of ports, and the ID codes are displayed on the user interface. The connecting ports provided by the Ethernet network switch are connected to at least one server blade, at least one management module or at least one network switch, and the user interface is a text-based user interface.

### BACKGROUND OF THE INVENTION

1. Field of the Invention

The present invention relates to a method of identifying and managing an electronic device, and more particularly, to a method of identifying and managing at least one device in a blade server.

2. Description of the Related Art

Please refer to FIG. 1. A blade server 10 can contain many different devices, such as a server blade 12, a fan module 16, a management module 18, and an Ethernet network switch 20. The server blade 12 is a powerful personal computer, which can provide operating, processing and temporary data storage functions, and which uses a video output port 14 to output video data to a monitor. The fan module 16 is used to adjust the temperature in the blade server 10 to ensure the stability of the blade server 10. Each server blade 12 and each management module 18 connect to one of the communication ports on the Ethernet network switch 20 for communication with an external network via an uplink port on the Ethernet network switch 20. Therefore, the Ethernet network switch 20 comprises a plurality of communication ports connected with the server blade 12, the management module 18 and the external network respectively. In order to smooth the network data flow on an internal network of the blade server 10 and the external network, the Ethernet network switch 20 is used for adjusting the data throughput or priority, so the server blade 12 can use the Ethernet network switch 20 to communicate with the external network to exchange data.

In general, the Ethernet network switch 20 can be of two different types: a common Ethernet network switch or an intelligent Ethernet network switch. The common Ethernet network switch does not support management functionality for the communication ports, and so cannot manage the internal network data flow or establish a virtual network in the blade server 10. The intelligent Ethernet network switch can manage the internal network data flow and establish a virtual network in the blade server 10. The prior art intelligent Ethernet network switch uses a graphical interface to help the user to manage and monitor networking operations, and the graphical interface is displayed on a monitor 24 and uses the communications interface to transmit a command output by a host 22 to the management module 18 or the Ethernet network switch 20 to manage the network. The communications interface can be RS-232, a networking communications interface, or USB. Please refer to FIG. 2. The prior art graphical interface is not without fault. Although the graphical interface can show the connections between the communication port and the above-mentioned devices to the user, the graphical interface requires special software and hardware and has a complicated design, which leads to higher hardware costs.

Therefore, it is desirable to provide a method of identifying and managing an electronic device to mitigate and/or obviate the aforementioned problems.

### SUMMARY OF THE INVENTION

A main objective of the present invention is to provide a method of identifying and managing an electronic device, which uses a user interface to identify at least one device in a blade server and enables the user to manage the blade server.

To achieve this objective, the present invention provides a method of identifying and managing network operations of an electronic device via a user interface in order to control operations of at least one Ethernet network switch in the electronic device, the method comprising: dividing at least one communication port provided by the at least one Ethernet network switch into at least one type; assigning at least one ID code to correspond to the at least one type; and assigning at least one sequentially different ID code to the corresponding type of the communication port and displaying the at least one ID code on the user interface; wherein the at least one communication port provided by the at least one Ethernet network switch is connected to at least one server blade, at least one management module or at least one Ethernet network switch, and the user interface is a text interface.

According to the present invention, a text interface is used for displaying the device connected to every connecting port. The text interface is easy for the user to operate and has simple software and hardware requirements.

Other objects, advantages, and novel features of the invention will become more apparent from the following detailed description when taken in conjunction with the accompanying drawings.

### BRIEF DESCRIPTION OF THE DRAWINGS

FIG. 1 is a schematic drawing of a blade server;

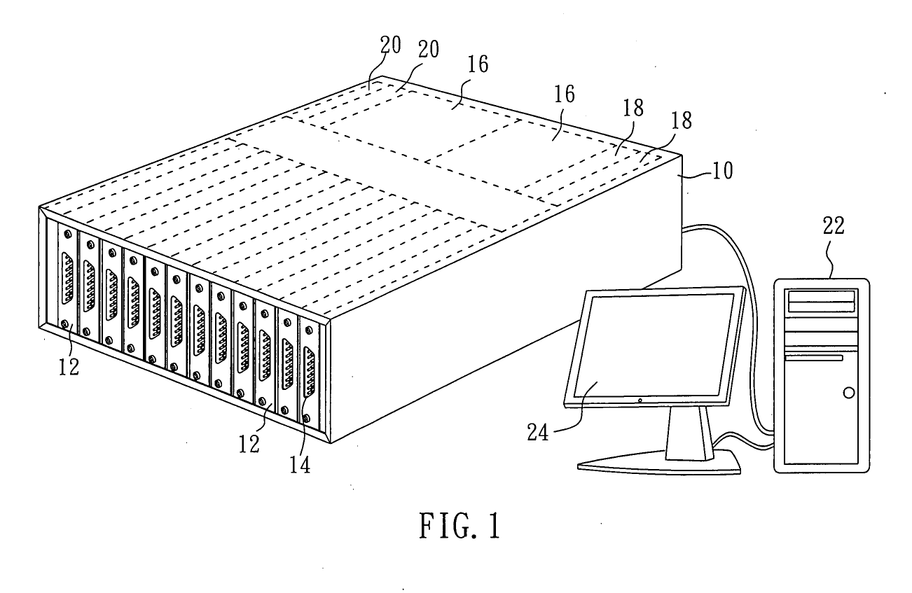

FIG. 2 shows a prior art graphical interface for managing network throughput;

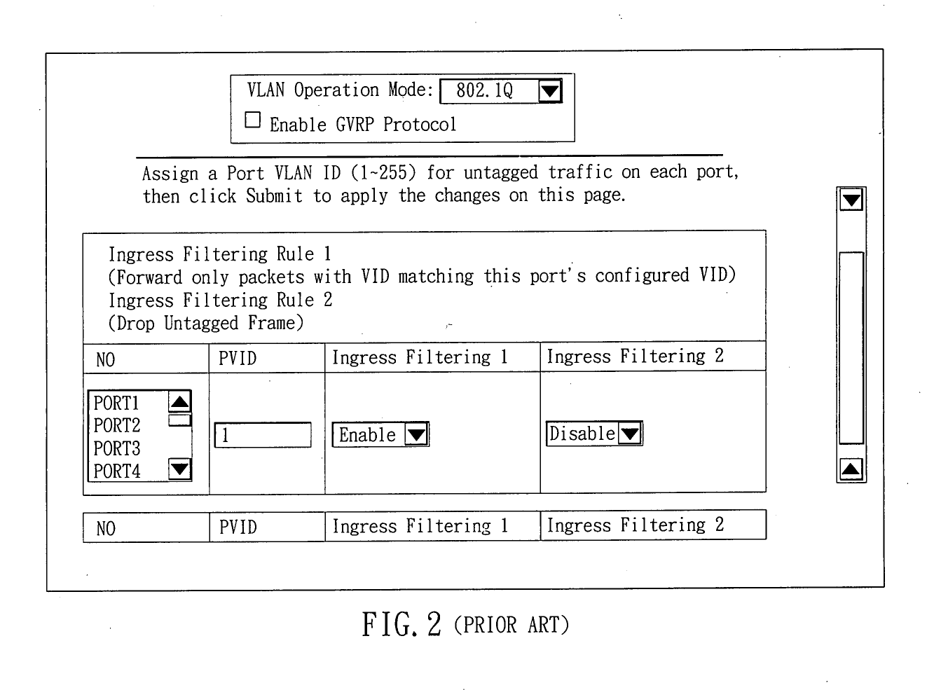

FIG. 3 is a flow-chart of a method of distinguishing and managing an electronic device according to the present invention;

FIG. 4 is a schematic drawing of a user interface according to the present invention; and

FIG. 5 is a schematic drawing of another user interface according to the present invention.

### DETAILED DESCRIPTION OF THE PREFERRED EMBODIMENT

By way of example, assume that the Ethernet network switch 20 provides 19 communication ports and divides all the devices connected to the communication ports into three different groups, and then individually assigns the groups three different ID code groups. The three groups include: fourteen blade ports, with respective ID codes from 1 to 14, for communication to fourteen blade servers 12; three uplink ports, with respective ID codes from 21 to 23, for communication to three external Ethernet network; two management ports, with respective ID codes of 31 and 32, for communication to two management modules 18. Since the different types of devices have different ID codes, the user can use the ID code to identify different devices; the sequence of the ID codes can be determined by positions (or slots) corresponding to the communication ports, or by the order of installing these above-mentioned devices into the blade server 10.

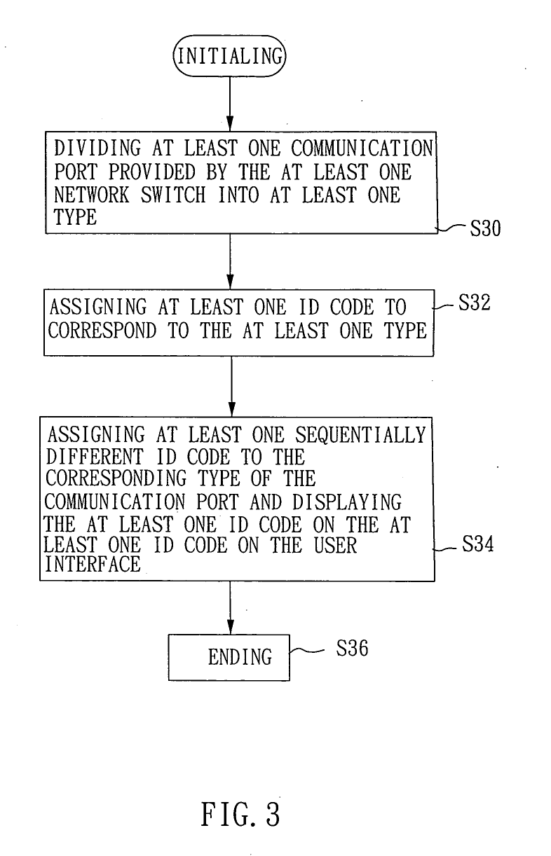

Please refer to FIG. 3. The method of the present invention uses a text interface as a user interface, which has simple software and hardware requirements, and further provides fast processing speeds; the text interface provides an ID code for each type of device. An execution process of the method is shown as follows:

Starting the process.

Step 30: dividing at least one communication port provided by the Ethernet network switch 20 into at least one type. For example, dividing all the connecting ports provided by the Ethernet network switch 20 into three types: for the server blades 12, for the external Ethernet network and for the management modules 18.

Step 32: assigning at least one ID code to correspond to the at least one type. For example, setting the ID codes 1 to 14 to correspond to the server blades 12; setting the ID codes 21 to 23 to correspond to the external Ethernet network; and setting the ID codes 31 and 32 to correspond to the management modules 18.

Step 34: assigning, in a sequentially different manner, at least one ID code to the corresponding type of port and displaying the at least one ID code on the user interface. The user can identify the device in accordance with its ID code; for example, ID code 2 is for the server blade 12 inserted into a second slot; ID code 22 is for a second external Ethernet network; and ID code 32 is for the management module 18 inserted into a second slot. Therefore, the user can monitor the user interface to identify the types of devices and their positions.

Ending the process.

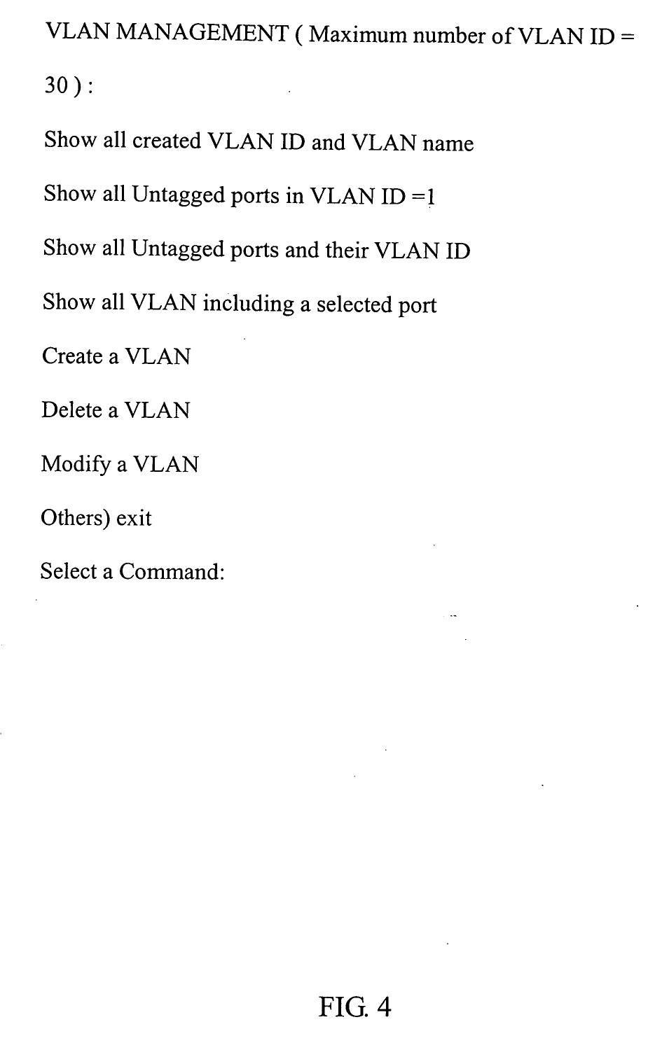

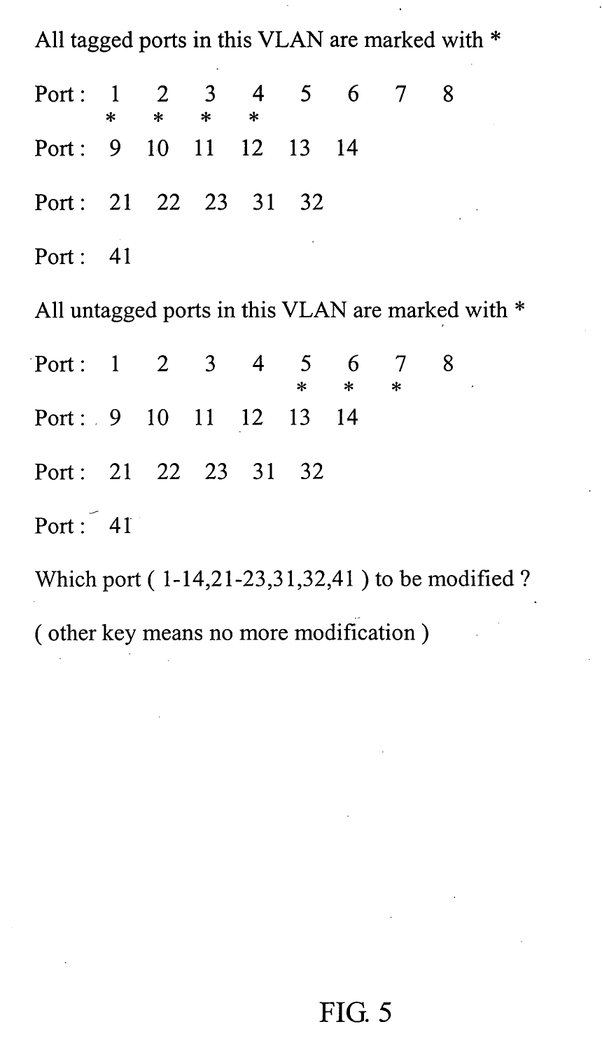

Please refer to FIG. 4. The method of identifying and managing an electronic device of the present invention uses the text interface as the user interface. Please refer to FIG. 5. The user monitors the ID code to manage the network data flow of one of the electronic devices.

According to the above-mentioned description, the present invention uses a text interface management functionality provided by the intelligent Ethernet network switch to manage the network throughput.

Although the present invention has been explained in relation to its preferred embodiment, it is to be understood that many other possible modifications and variations can be made without departing from the spirit and scope of the invention as hereinafter claimed.

1. A method of identifying and managing network operations of an electronic device via a user interface in order to control operations of at least one Ethernet network switch in the electronic device, the method comprising:
dividing at least one communication port provided by the at least one Ethernet network switch into at least one type;
assigning at least one ID code to correspond to the at least one type; and
assigning at least one sequentially different ID code to the corresponding type of the communication port and displaying the at least one ID code on the user interface;
wherein the at least one communication port provided by the at least one Ethernet network switch is connected to at least one server blade, at least one management module or at least one Ethernet network switch, and the user interface is a text interface.

2. The method as claimed in claim 1, wherein the electronic device is a blade server.

3. The method as claimed in claim 1, wherein the user interface is placed in a terminal and the terminal uses a communications interface to communicate with the computer device.

4. The method as claimed in claim 3, wherein the communication interface is an RS-232 interface, a network communication interface, or a USB interface.
